(19) United States
(12) Patent Application Publication
(10) Pub. No.: US 2022/0168884 A1
(43) Pub. Date: Jun. 2, 2022

(54) LOW TOUCH UTENSIL

(71) Applicant: R&L MARKETING & SALES, INC., Youngstown, OH (US)

(72) Inventors: Ronald N. Kessler, Girard, OH (US); David M. Neill, Canfield, OH (US)

(73) Assignee: R&L MARKETING & SALES, INC., Youngstown, OH (US)

(21) Appl. No.: 17/109,491

(22) Filed: Dec. 2, 2020

(51) Int. Cl. B25G 1/10; A45C 11/32; E05B 17/00; A01N 25/10; B25F 1/00

(52) U.S. Cl. CPC B25G 1/102; A45C 11/321; B25F 1/00; A01N 25/10; E05B 17/00

(57) ABSTRACT

A device for reducing direct contact between a person's hand and an object in their environment. The device is a low touch utensil comprising a body with a top surface, a bottom surface, and a peripheral wall extending therebetween. A handle provided on the body is grasped in a single hand of a user. The user manipulates the body to bring at least one region of the utensil's body into contact with a surface of an object in their environment, particularly a surface the user might think is contaminated with viruses, bacteria or other substances. The user manipulates the body to apply a pushing force on the object or a pulling force on the object in order to move the object, activate a function of the object, or deactivate a function of the object. The contact region on the body may be a specially configured region of the peripheral wall.

### TECHNICAL FIELD

This disclosure is directed to protective devices. More specifically, the disclosure is directed to a device that reduces a level of touch or contact between a person's hand and various hard surfaces upon which contaminants may be present. Particularly, the disclosure is directed to a hand-held device that includes a plurality of different contact regions that are configured to enable a person to interact and/or manipulate hard surfaces in the person's environment.

### BACKGROUND

### Background Information

In the present pandemic that is sweeping the world, it has become evident that the COVID-19 coronavirus may be picked up when a person come into contact with bodily fluid droplets on hard surfaces. These droplets of bodily fluids may come to rest on the hard surfaces if a person infected with coronavirus coughs, sneezes, or talks in the immediate vicinity of the hard surfaces. Another person may then touch that droplet-covered surface with their hands and then inadvertently touch their eyes, nose, or mouth. In this inadvertent contact with the droplets, the second person may contract the virus. Apart from the COVID-19 coronavirus, other viruses and bacteria may similarly be picked up through contact with hard surfaces.

If people suspect that a surface of an object in their environment might be contaminated with viruses, bacteria, or any undesirable substance, they may pull out their car keys, a pen, or a credit card and use these implements to depress an elevator button or the buttons on a payment terminal. Articles like pens, keys, or payments cards cannot be used for anything more than depressing the occasional button. This still leaves people without many options to pull perform actions like opening and closing doors or drawers, activating touchscreens, and switching lights on and off without directly coming into personal physical contact with the doors, drawers, etc.

### SUMMARY

The present Applicant has recognized that there is need for a device that will enable a user to perform a wide variety of actions that involve manipulating objects in their environment while reducing the degree of direct physical contact between the person and the objects in their environment.

The low touch utensil disclosed herein is one such device. The disclosed utensil is readily able to be grasped by the user and can be manipulated to apply a pushing force and/or a pulling force on various objects in the user's environment. The disclosed utensil is also readily able to perform a sweeping type action across sensitive surfaces such as touchscreens. The disclosed low touch utensil is a multifunctional tool that may aid a user in everyday living while simultaneously aiding in preventing the user from coming into direct contact with viruses, bacteria, and other contaminants on hard surfaces in the user's environment.

The device has a unique shape that presents a number of differently-configured surfaces that will assist a user to perform a wide variety of tasks. The utensil may, for example, help a user in opening and closing doors, turning light switches on or off, depressing buttons on keypads, photocopiers etc. to activate or deactivate these devices, and pulling, or pushing levers to flush toilets. All of these actions can be performed without the user's hands coming into direct contact with the hard surfaces of the doors, light switches etc.

The present disclosure relates to a device for reducing direct contact between a person's hand and an object in their environment. The device is a low touch utensil comprising a body with a top surface, a bottom surface, and a peripheral wall extending therebetween. A handle provided on the body is grasped in a single hand of a user. The user manipulates the body to bring at least one region of the utensil's body into contact with a surface of an object in their environment, particularly a surface the user might think is contaminated with viruses, bacteria or other substances. The user manipulates the body to apply a pushing force on the object or a pulling force on the object in order to move the object, activate a function of the object, or deactivate a function of the object. The contact region on the body may be a specially configured region of the peripheral wall.

In one aspect, an exemplary embodiment of the present disclosure may provide a device for reducing direct contact between a person's hand and an object in the person's environment, wherein the device comprises a body having a top surface and opposed bottom surface, and a peripheral wall extending between the top surface and the bottom surface; a handle provided on the body; at least one region of the body adapted to apply a pushing force on the object in the person's environment; and at least one region of the body adapted to apply a pulling force on the object in the person's environment.

In one embodiment, the at least one region of the body that may apply the pushing force and the at least one region that may apply the pulling force are a same region of the body. In one embodiment, the at least one region that may apply the pushing force and the at least one region that may apply the pulling force are different regions of the body. In one embodiment the peripheral wall of the body may include one or more of a convex surface, a concave surface, a surface including at least one straight edge, a hook, and a projection. In one embodiment, the at least one region of the body that may apply the pushing force on the object may be one of the one or more of the convex surface, the concave surface, the surface including at least one straight edge, the hook, and the projection on the peripheral wall. In one embodiment, the at least one region of the body that may apply the pulling force on the object may be one of the one or more of the convex surface, the concave surface, the surface including at least one straight edge, the hook, and the projection on the peripheral wall. In one embodiment, the body may be configured generally as a number “6” when the top surface is viewed from above. In one embodiment, the body may be molded from a polymer. In one embodiment the body may be molded from a material that is one or both of cleanable and solvent resistant. In one embodiment, the body may be molded from a material that includes an antimicrobial agent. In one embodiment, at least a portion of the body may be overmolded.

In one embodiment, a first aperture may be defined in the body and extend between the top surface and the bottom surface; and wherein a first region of the body may at least partially circumscribe the first aperture; and wherein the first region may comprise the handle that is adapted to be held by the person. In one embodiment, a second aperture may be defined in the body; wherein the first aperture and second aperture may be separated from each other by a second region of the body. In one embodiment the second aperture may be defined in the body originating in an opening in the peripheral wall and extending for a distance into the body; and wherein a third region of the body may at least partially circumscribe the second aperture and form a hook. In one embodiment a hole may be defined in the body and extend between the top surface and the bottom surface, said hole being adapted to receive a fastener therethrough which secures the body to an article in the person's possession.

In another aspect, an exemplary embodiment of the present disclosure may provide a method of reducing direct physical contact between a person's hand and an object in the person's environment comprising providing a low touch utensil; holding a body of the low touch utensil in one hand; applying a pushing force on the object in the person's environment with a first region of the body or applying a pulling force on the object in the person's environment with the first region of the body or with a second region of the body; and maintaining the person's hand a distance away from the object with the body while applying the pushing or pulling force.

In one embodiment, the method may further comprise providing a top surface and opposed bottom surface on the body of the low touch utensil; providing a peripheral wall on the body, where the peripheral wall extends between the top surface and the bottom surface; providing the first region and the second region of the body on the peripheral wall; and applying the pushing force or the pulling force with the peripheral wall. In one embodiment, the method may further comprise providing a handle on the body; holding the body by grasping the handle; and applying the pushing force or the pulling force with a surface of the body that is located a distance away from the handle.

In another aspect, and exemplary embodiment of the present disclosure may provide a method of reducing a likelihood of infection from bacteria or viruses on objects in a person's environment comprising providing a low touch utensil; holding a body of the low touch utensil in one hand; placing a surface of a first region of the body in direct contact with a contaminated object in the person's environment; selectively using the body of the low touch utensil to apply a pushing force on the contaminated object or to apply a pulling force on the contaminated object; and preventing contact between the person's hand and the contaminated object with the body while applying the pushing or pulling force.

In one embodiment, the method may further comprise forming the body of the low touch utensil from a material that includes an antimicrobial agent; and killing bacteria or viruses on an exterior surface of the body of the low touch utensil with the antimicrobial agent. In one embodiment, the method may further comprise forming the body of a material that is easily cleaned and is not susceptible to damage from chemical solvents that kill viruses and/or bacteria.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front, left side, isometric, perspective view of a low touch utensil in accordance with an aspect of the present disclosure;

FIG. 1A is a front, left side, isometric, perspective view of the low touch utensil showing overmolding on a handle portion of the utensil;

FIG. 2 is a top plan view of the device of FIG. 1;

FIG. 3 is a bottom plan view thereof;

FIG. 4 is a front elevation view thereof;

FIG. 5 is a rear elevation view thereof;

FIG. 6 is a right side elevation view thereof;

FIG. 7 is a left side elevation view thereof;

FIG. 8A is a first operational view of the low touch utensil held in a user's right hand and being used to pull open a door;

FIG. 8B is a second operational view of the low touch utensil held in a user's right hand and being used to push open a door;

FIG. 8C is third operational view of the low touch utensil held in a user's right hand and being used to engage a light switch in order to switch a light on or off;

FIG. 8D is a fourth operational view of the low touch utensil held in a user's right hand and being used to depress buttons on a payment terminal.

FIG. 8E is a fifth operational view of the low touch utensil held in a user's right hand and being used to flush a toilet;

FIG. 8F is a sixth operational view of the low touch utensil engaged with a key ring.

Similar numbers refer to similar parts throughout the drawings.

### DETAILED DESCRIPTION

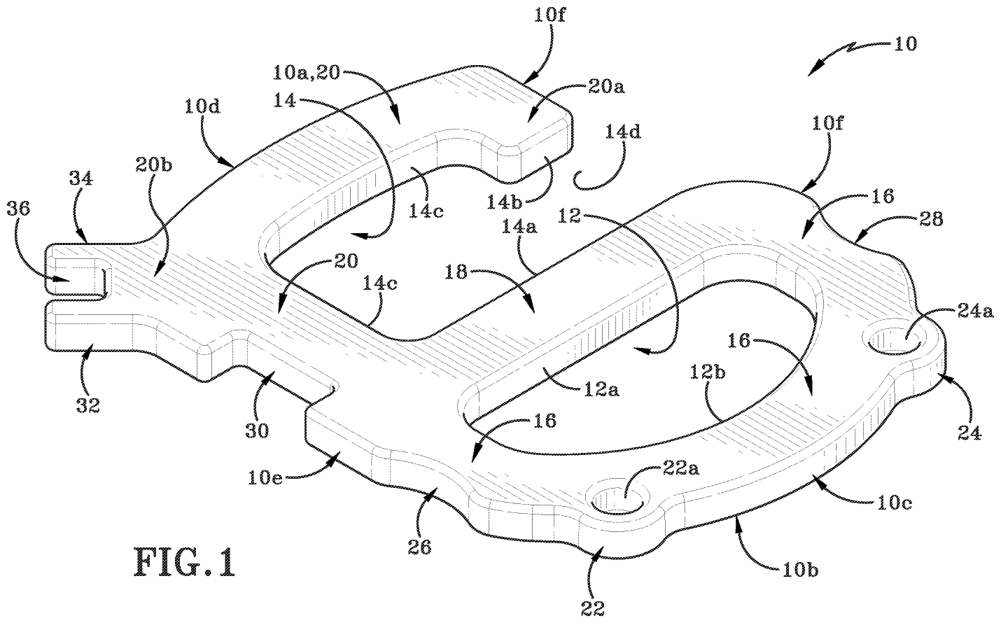

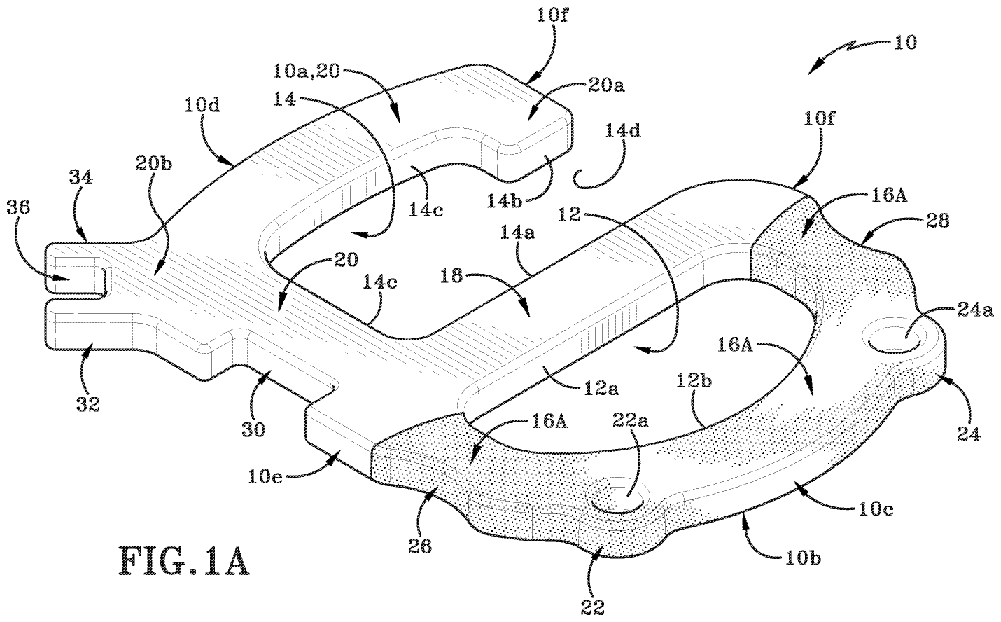

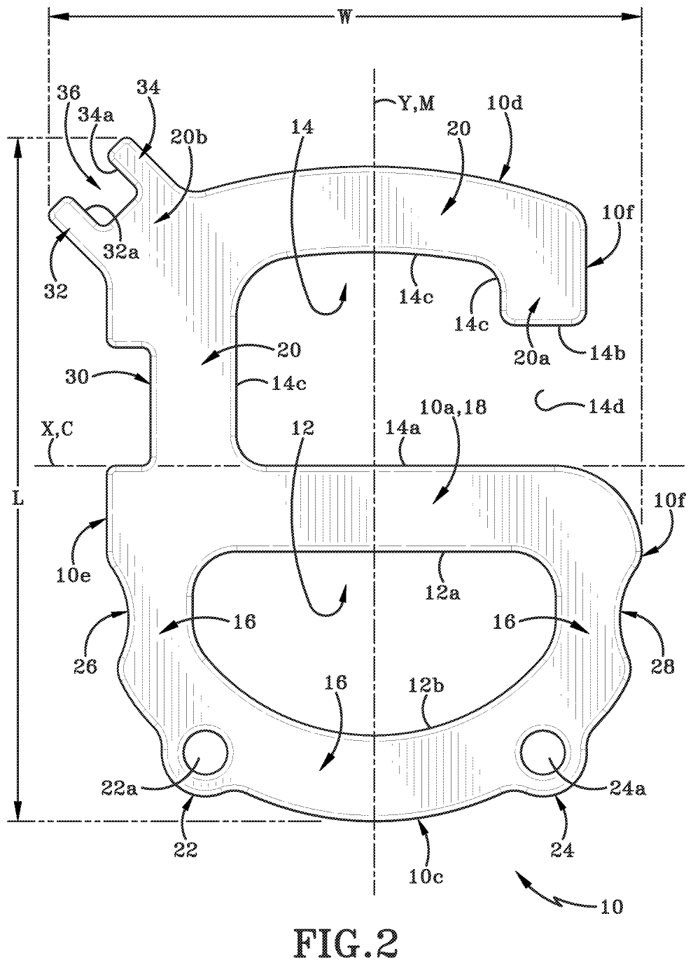

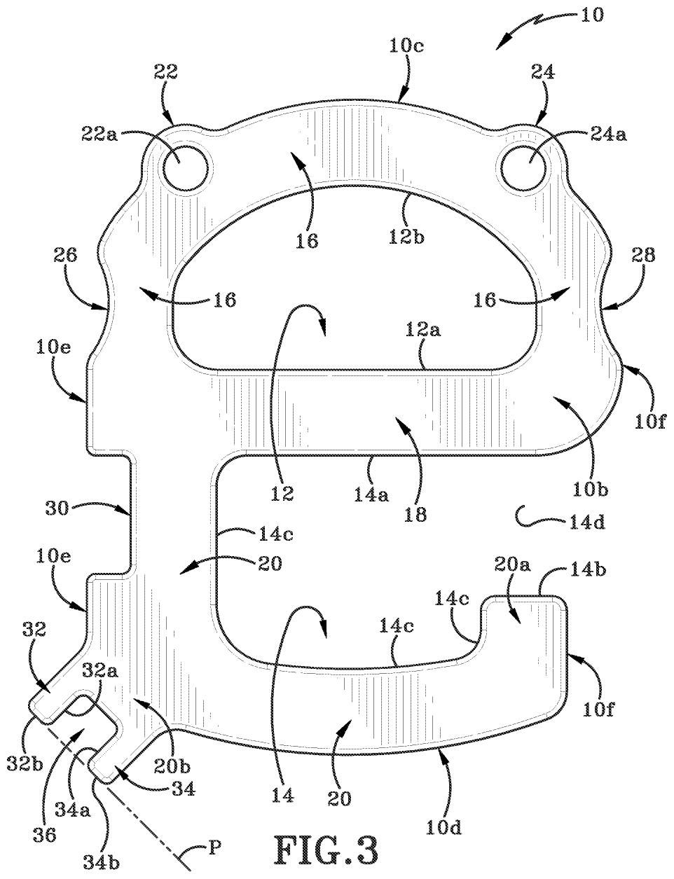

Referring to FIGS. 1-7, there is shown a low-contact device in accordance with the present disclosure, generally indicated at 10. Device 10 comprises a body that, when viewed in the orientation shown in FIG. 2, generally has the appearance of a stylized number “6”. When the body is viewed in the orientation shown in FIG. 3, the body generally has the appearance of an inverted number “6” or a rotated mirror image of the number “6”.

The body of device 10 may be molded from a wide variety of suitable materials. Suitable materials for device 10 preferably are materials which are easily cleaned and are solvent resistant. In particular the material should not be adversely affected by chemicals typically used to sanitize hard surfaces. Preferably, a suitable antimicrobial agent and/or antifungal agent is added to the material during production of the material or device 10. The antimicrobial agent is utilized to inhibit or prevent growth or multiplication of bacteria and viruses on the surface of the body of device 10 and thus will aid in preventing the transfer of surface-borne bacteria and viruses from the device to the user by indirect contact. Suitable materials for fabricating device 10 include polymers such as Acrylonitrile Butadiene Styrene (ABS) plastic. One suitable antimicrobial agent that may be added to such polymers is MICROBAN® (MICROBAN is a registered trademark of Microban Products Company of Huntersville N.C., USA).

Device 10 may be fabricated in a range of different colors. The edges of the body that might be contacted by a person using the device 10 may be beveled, chamfered, rounded, or otherwise shaped so that the body does not present any sharp edges and corners that may accidentally injure the user. In one embodiment, the body of device 10 is molded as a one-shot or two-shot injection process with rigid/soft areas for optimized integration and functionality.

Referring still to FIGS. 1-7, device 10 is described in greater detail. The body of device 10 has a top surface 10a, a bottom surface 10b (FIG. 3), a front end 10c, a rear end 10d, a left side 10e, and a right side 10f. When device 10 is viewed in the orientation shown in FIG. 2, i.e., with the top surface 10a facing the viewer of the figure and the rear end 10d located a distance vertically above the front end 10c, device 10 generally has an appearance of a stylized number “6” with a longitudinal axis “Y” that extends between front end 10c and rear end 10d along a longitudinal midline “M” of the device 10. Device 10 further includes a lateral axis “X” that extends between left side 10e and right side 10f along a lateral centerline “C” of the device 10. The longitudinal axis “Y” and lateral axis “X” are oriented at right angles to each other and therefore the midline “M” and centerline “C” are oriented at right angles to each other. As is evident from FIG. 2, device 10 is not symmetrical about longitudinal midline “M” nor is device 10 symmetrical about lateral centerline “C”. In particular, the left side 10e of the device 10 is differently configured from the right side 10f of the device 10. Additionally, the front end 10c of the device 10 is differently configured from the rear end 10d of device 10.

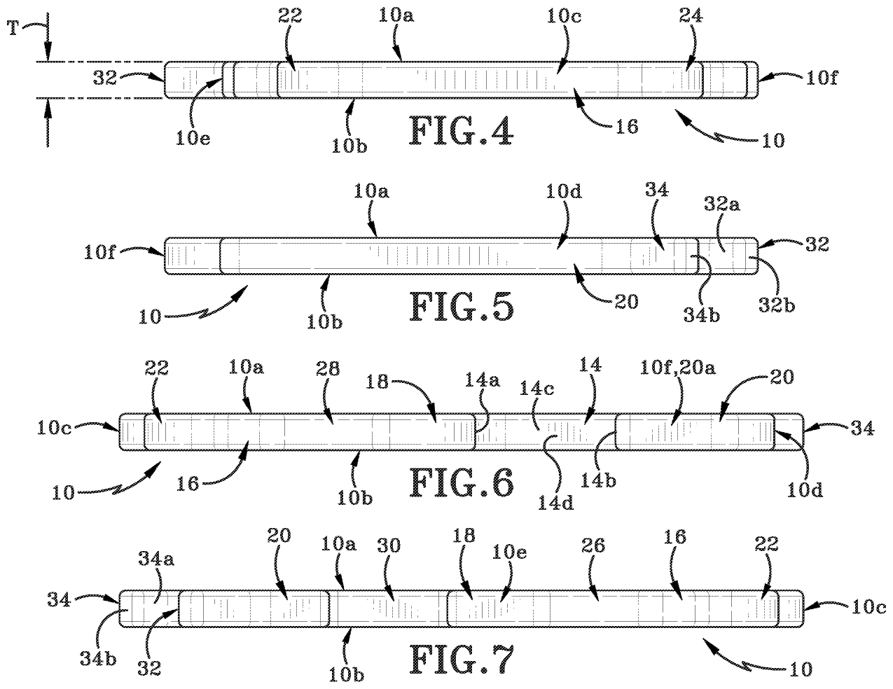

Device 10 is of a maximum height “L” measured between an outermost region of front end 10c and an outermost region of rear end 10d. Device 10 is of a maximum width “W” measured between a left-most region of the left side 10e and the right-most region of the right side 10f. Device furthermore is of a generally constant thickness “T” (FIG. 4) measured between top surface 10a and bottom surface 10b.

In accordance with the disclosed configuration of device 10, a first aperture 12 and a second aperture 14 are defined in the body. Each of the first aperture 12 and second aperture 14 extends from top surface 10a to bottom surface 10b. First aperture 12 is generally an inverted semi-circular shape and is defined by an inner straight wall 12a of the body and an inner arcuate, C-shaped wall 12b of the body. The straight wall 12a is substantially parallel to the lateral axis “X” and spaced a distance away from the centerline “C” towards front end 10c. The arcuate, C-shaped wall 12b is located a distance inwardly from front end 10c and portions of left and right sides 10e, 10f.

Second aperture 14 is generally P-shaped and is defined by a straight first inner wall 14a and a straight second inner wall 14b that each originate in right side 10f and extends toward left side 10e. First and second inner walls 14a, 14b are generally parallel to each other and spaced a distance longitudinally apart from each other. First inner wall 14a is longer than second inner wall 14b in that first inner wall 14a terminates a first distance inwardly from left side 10e and second inner wall 14c terminates a second distance inwardly from left side 10e, with the second distance being greater than the first distance. A generally U-shaped third inner wall 14c defines a remainder of the P-shape and extends between first inner wall 14a and second inner wall 14b. An opening 14d to second aperture 14 is defined in right side 10f of the body. Second aperture 14 thus can be considered to originate in an opening 14d defined in right side 10f of the body. Second aperture 14 extends from this opening 14d for a distance into the body and towards left side 10e and furthermore extends rearwardly towards rear end 10d.

The formation of first aperture 12 and second aperture 14 causes body to be divided into various regions. A first region, generally indicated at 16, is generally U-shaped and is located between the C-shaped wall 12b and a portion of a peripheral wall/edge of the body defined by front end 10c and lower portions of left side 10e and right side 10f (when considering the orientation of device 10 shown in FIG. 2). The U-shaped first region 16 forms a handle by which a user may grip device 10.

A second region of the body, generally indicated at 18, is generally rectangular in shape and extends between first aperture 12 and second aperture 14. Second region 18 is oriented generally parallel to lateral axis “X”. A first side of the second region 18 is defined largely by the straight inner wall 12a that defines part of first aperture 12. A second side of the second region 18 is defined largely by the straight first inner wall 14a that defines part of second aperture 14. The second region 18 effectively extends across the mouth of the C-shaped first region 16. Together, the first region 16 and second region 18 form a D-shaped portion of the body. The second region 18 acts as a strengthening member in the body and provides some rigidity and structure thereto.

A third region of the body, generally indicate at 20, is generally “R”-shaped, originating at one end of second region 18 (in particular proximate left side 10e) and at least partially circumscribing second aperture 14. The third region 20 extends outwardly from second region 18 moving in a direction away from first region 16 and then turns through approximate ninety degrees and extends towards right side 10f. A free end 20a of third region 20 terminates in the second inner wall 14b and is separated from a second region 18 by opening 14d. Third region 20 forms a hook that can readily be seen in FIG. 2.

The body has a peripheral wall extending between top surface 10a and bottom surface 10b and forming the outermost edge of the device 10. This outermost edge is comprised of front end 10c, left side 10e, rear end 10d, a first portion of right side 10f, second inner wall 14b, third inner wall 14c, first inner wall 14a, a second portion of right side 10f, terminating at rear end 10d. The peripheral wall is configured to form variously-shaped surfaces including convex surfaces, concave surfaces, indents, projections, depressions, straight edges, and hooks, as will be described hereafter. These variously-shaped convex and concave surfaces, indents, projections, straight edges, depressions, and hooks may be utilized by the user to interact with their environment is a low touch manner.

The various edges, indents, and handle of the device 10 may be overmolded via either rotary or pick and place technology. Any desired region of the body of device 10 may be overmolded with a lower durometer material to enhance comfort and performance of device 10 and to increase slip resistance. FIG. 1A, for example, shows device 10 where the first region 16A, i.e., the handle, has been overmolded.

Starting with front end 10c, as is evident from FIGS. 1 and 2, front end 10c is a convexly-curved surface that extends between a rounded first corner 22 and a rounded second corner 24. Front end 10c intersects with left side 10e at first corner 22 and with right side 10f at second corner 24. A first hole 22a is defined in first corner 22 and extends between top surface 10a and bottom surface 10b. A second hole 24a is defined in second corner 24 and extends between top surface 10 and bottom surface 10b. Front end 10c curves outwardly beyond each of the first corner 22 and second corner 24 as can be seen in FIG. 2. In particular, a central portion of front end 10c is located a distance longitudinally further outwardly that each of the first corner 22 and second corner 24.

A short distance longitudinally upwardly from first corner 22 and along left side 10e, a first depression 26 is defined by the peripheral wall. The first depression 26 is concave and has a substantially constant radius of curvature. First depression 26 is located on first region 16 such that when a user grips the device 10 in their right hand, the gently curved front end 10c will rest against the user's palm and the user's right thumb will be seated in first depression 26. This configuration makes device 10 comfortable to grip and manipulate.

A short distance longitudinally upwardly from second corner 24 and along right side 10f, a second depression 28 is defined by the peripheral wall. The second depression 28 is effectively a mirror image of first depression 26. As such, second depression 28 is concave and has a substantially constant radius of curvature. Second depression 28 is located on first region 16 such that when a user grips the device 10 in their left hand, the gently curved front end 10c will rest against the user's palm and the user's left thumb will be seated in second depression 28. Again, this configuration makes device 10 comfortable to grip and manipulate. The curved front end, first depression 26 and second depression 28 provide ergonomic features on device 10 that make device suitable for use in either of a left hand or right hand of the user.

A further distance longitudinally upwardly from the first depression 26 along left side 10e, the peripheral wall defines a recess 30. Recess 30 is generally located a short distance longitudinally upwardly from where the third region 20 originates in second region 18. Recess 30 is generally rectangular in shape and extends longitudinally for a distance along left side 10e. Recess 30 is defined by three straight edges that are generally oriented at right angles to one another. The recess 30 has a greater length (measured in a same direction as the length “L” of device 10) than width (measured in a same direction as the width “W” of device 10). As will be described later herein, device 10 may be manipulated by a user to cause part of an object in the user's environment to enter recess 30. Depending on the way the part of the object is receives within recess 30, one or more of the straight edges that define recess 30 may be caused to apply either a pushing force or a pulling force on the part of the object received in the recess. The pushing force is applied by the user moving the body of device 10 in one direction. The pulling force is applied by the user moving the body of the device 10 in another direction.

At approximately the corner of the “R” shape of third region 20, where the corner is identified by the reference character 20b in FIG. 2, the peripheral wall of device 10 defines a first projection 32 and a second projection 34 that extend outwardly from the body. First projection 32 is laterally spaced a distance away from second projection 34 such that an indent 36 is defined between an inner surface 32a (FIG. 2) of first projection 32 and an inner surface 34a of second projection 34. First and second projections 32, 34 are generally parallel to each other (or at least the inner surface 32a of first projection 32 is generally parallel to inner surface 34a of second projection 34). Each of the first projection 32 and second projection 34 extends outwardly from the body at an angle of from about 40° up to about 50° relative to longitudinal axis “Y”. In one embodiment, each of the first projection 32 and second projection 34 is oriented at an angle of about 45° relative to longitudinal axis

First projection 32 terminates in a free end 32b (FIG. 3) and second projection 34 terminates in a free end 34b. Free end 32b is substantially aligned with free end 34b along the same plane “P”. Each of the first projection 32 and second projection 34 is generally rectangular in shape and is comprised of three straight edges oriented at right angles to one another. For example, the first projection 32 is defined by the straight inner surface 32a and a straight, opposed outer surface (not numbered) that is parallel to inner surface 32a. The free end 32b extends between the inner surface 32a and opposed outer surface. Free end 32b is also straight. Second projection 34 is substantially similarly configured. First projection 32 and second projection 34 are substantially of a same overall length. The indent 36 defined between first projection 32 and second projection 34 is generally square in configuration when viewed from above as in FIG. 3. As such, indent is of substantially equal length and width. In particular, indent 36 is of a length and width suitable for receiving or capturing a toggle switch or a slide switch of an electric light switch therein and gripping the same so that the toggle switch or slide switch can be moved between an on position and an off position, as will be later described herein. Alternatively, the substantially flat free end 32b and/or free end 34b of the first and second projections 32, 34 may be used to depress, engage or otherwise manipulate a decorator switch, rocker switch or gang switch to move the same between an on position and an off position. The flat or straight opposed outer surfaces of first projection 32 or second projection 34 may be used to apply a pushing force or a pulling force on an object in the person's environment. Similarly, the flat or straight inner surfaces 32a, 34a may be used to apply a pushing force or a pulling force on an object in the person's environment.

The portion of the peripheral wall of device 10 that comprises rear end 10d extends between the corner 20b of third region 20 and right side 10f. FIG. 2 shows that rear end 10d is convex in shape, being gently arcuate curved. As will be described hereafter, the convexly shaped rear end 10d is particularly suitable for contacting and pushing on hard surfaces in the user's environment.

An upper portion of right side 10f extends downwardly from rear end 10d and towards front end 10c, terminating in second inner wall 14b proximate opening 14d. The terminal end 20a of the third region 20 that includes the upper portion of right side 10f and part of the third inner surface 14c forms a hook on the body. This hook may be used for a user to grasp onto objects and pull those objects towards themselves, as will be later described herein. The terminal end 20a includes a straight section of the right side 10f of body 10 and second inner wall 14b is also straight. The straight sections of right side 10f and inner wall 14b may be used to apply a pushing force to objects in the person's environment.

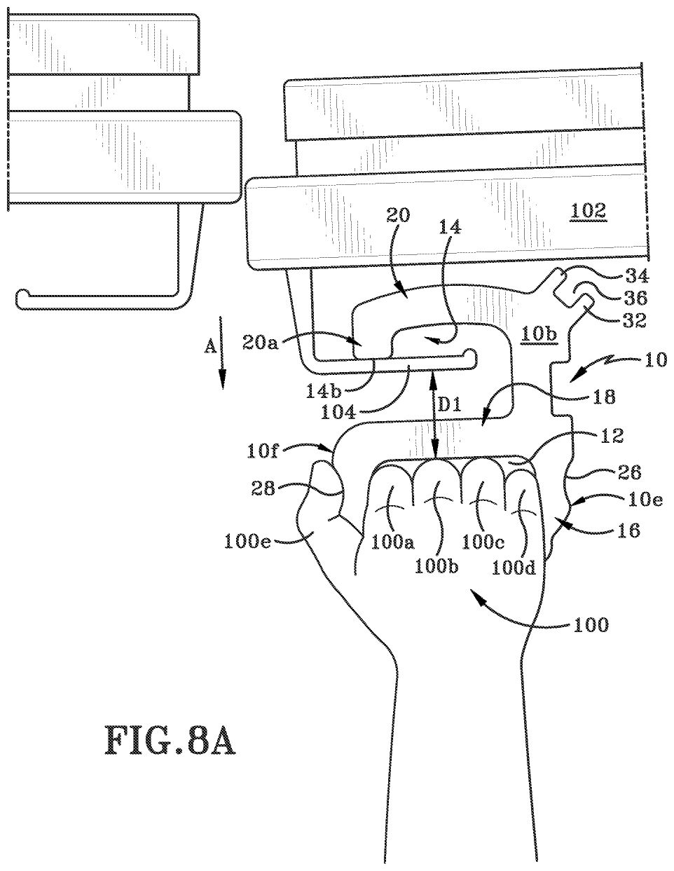

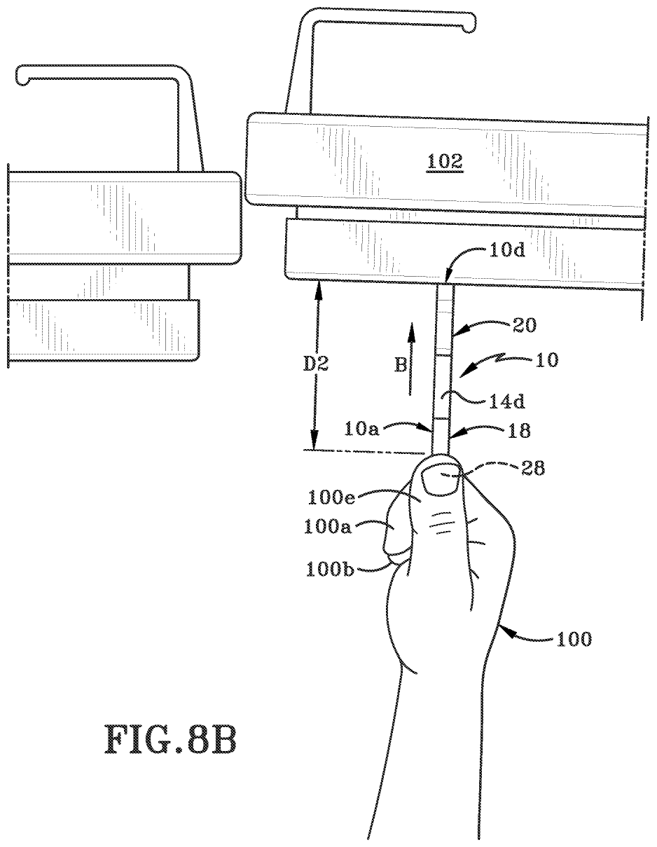

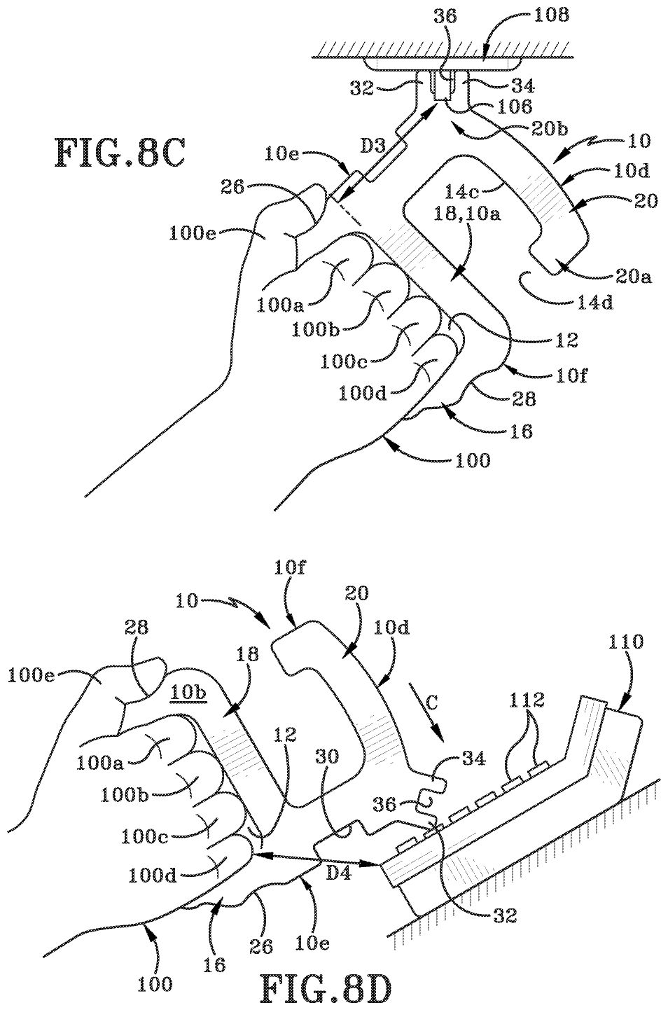

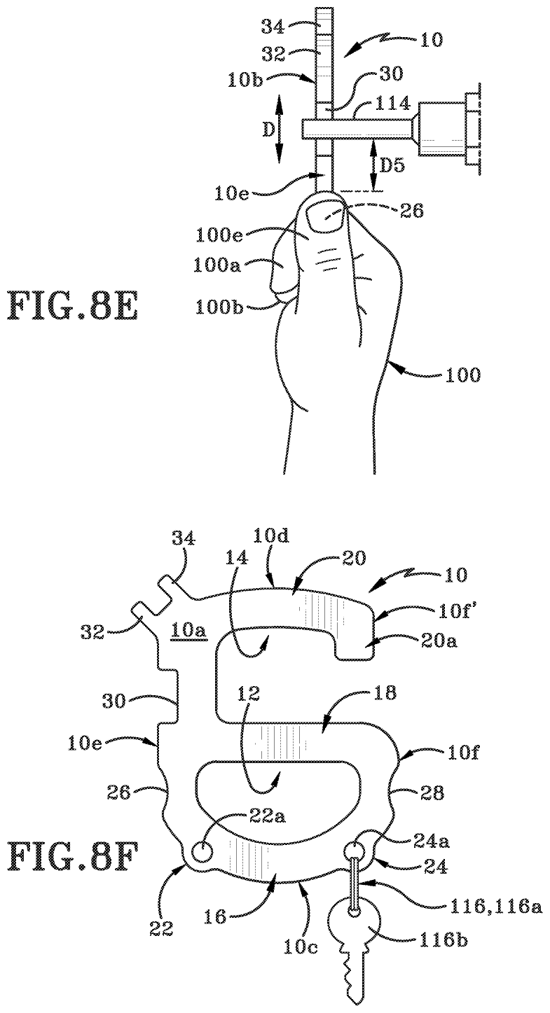

Referring now to FIGS. 8A through 8F device 10 is shown in use interacting with various hard surfaces that a person might find in their everyday environment. It should be understood that the scenarios depicted in FIGS. 8A through 8F are exemplary only and shouldn't be interpreted as narrowly limiting the manner in which device 10 may be utilized to minimize contact between a person's hand 100 and an object.

Turning now to FIG. 8A, device 10 is illustrated as being useful for pulling an object, such as the door 102 shown herein, in a direction “A” towards a person's body. The device 10 is shown grasped in the person's right hand 100. In particular, the person's fingers 100a, 100b, 100c, 100d are shown as being inserted through the first aperture 12. Although not illustrated herein, it should be understood that the front end 10c (FIG. 2) of device 10 abuts the palm of the person's right hand 100 and the person grips the first region 16 (FIG. 2) of device 10.

It will be understood that while the attached figures show four fingers 100a, 100b, 100c, and 100d inserted through first aperture 12, it will be understood that in other embodiments, the body and/or the first aperture 12 may be shaped and sized to receive fewer than four fingers through first aperture 12. For example, only a single finger (finger 100a) for example, may be inserted through first aperture 12. In other embodiments, the first aperture may be shaped and sized to receive two fingers therethrough or four fingers therethrough.

Because of the orientation of the device 10 (with bottom surface 10b facing the viewer of the figure), the person's thumb 100e rests in second depression 28 of device 10. While firmly grasping device 10, the user will manipulate device 10 such that a handle 104 on door 102 is engaged. As illustrated, the second inner surface 14b defining second aperture 14 contacts a rear surface of handle 104 and the person can then pull handle 104 and thereby door 102 towards them in the direction of arrow “A”. Alternatively, the person could manipulate and orient device 10 such that a portion of handle 104 is captured by the hook 20a formed by third region 20 of device 20. Device 10 could be pulled downwardly to disengage a latch (not shown) on the door handle 104 and then handle 104 and door 102 could be pulled towards the person's body. Still further, device 10 could be manipulated and oriented to capture the handle 104 with hook 20a in such a way that pulling upwardly on device will disengage a latch on the door handle. When the latch is disengaged, then the handle 104 and thereby the door 102 may be pulled towards the person's body. In particular, device 10 is used to pull the object, i.e., door 102 towards the person without the person's hand 100 directly contacting the door 102.

FIG. 8B shows a different scenario. In this instance, the user grasps device 10 in the same manner as illustrated in FIG. 8A. The user places convexly curved rear end 10d against the back of door 102 and moves the device 10 in the direction indicated by arrow “B”. Moving device 10 in this fashion pushes the door 102 open. In other instances, device 10 might be used in a similar fashion to push door 102 closed. In particular, device 10 is used to push the object, i.e., door 102 away from the person without the person's hand 100 directly contacting the door 102.

FIG. 8C shows device 10 held differently from the scenarios illustrated in FIGS. 8A and 8B. In this instance, device 10 is grasped in the user's right hand 100 so that top surface 10a is facing the viewer of the figure. The person's fingers 100athrough 100d are inserted through the first aperture 12 in such a way that the front end 10c of device 10 rests against the user's palm and the user's thumb 100e rests in first depression 26. Device 10 is shown being used to move a toggle switch 106 on a light switch 108 between an off position and an on position. In particular, toggle switch 106 is received in the indent 36 and the ends of first and second projections 32, 34 ride along the exterior surface of light switch 108 either in a first direction towards the viewer of the figure or in a second direction away from the viewer. As the device 10 is moved in one of the first direction or the second direction, the light operatively engaged with the light switch 108 is switched on. When the device 10 is moved in the other of the first direction or the second direction, the light that is operatively engaged with light switch 108 is switched off without the person's hand 100 directly contacting the toggle switch 106.

FIG. 8D shows device 10 being used to activate a payment terminal 110. In particular, device 10 is used to depress buttons 112 on payment terminal 110 without the person's hand 100 directly contacting buttons 112 and payment terminal 110. Device 10 is held in the person's hand in the same manner as illustrated in FIG. 8A. The user depresses a selected button 112 by bringing one of the first projection 32 and the second projection 34 into contact with the selected button 112. In particular, the user has positioned device 10 so that the free end of section projection 34 is in contact with the selected button 112. The user then moves their hand 100 in such a way as to move device 10 in the direction indicated by arrow “C”.

FIG. 8E shows device 10 being used to flush a toilet. The user grasps device 10 in an orientation similar to that shown in FIG. 8C. The device 10 is then manipulated to capture a part of a toilet flush handle 114 in the recess 30. Depending on how exactly the particular toilet flushes, handle 114 may be pushed or pulled as indicated by the arrow “D” to cause the toilet to flush. The toilet is therefore flushed without the user's hand 100 coming into direct contact with the flush handle 114.

FIG. 8F shows device 10 engaged with a key ring 116. In particular, a ring 116a upon which a key 116b is secured is engaged threadedly inserted through second hole 24a defined in the first region 16 of device 10. Obviously, key ring 116 could have been engaged with device 10 via first hole 22a. A user could secure device 10 to a set of car keys, for example, so that device 10 is always ready and available for use. In other instances, a carabiner, D-clip, S-clip, or other fastener may be inserted through one of the first and second holes 22, 24 and then be attached to a purse, gym bag, belt, or any other article owned by the user so that the device 10 is readily available for use.

It will be understood that the user may utilize any other suitable surface on device 10 to push on objects. For example, the portion of right side 10f identified in FIG. 8E as portion 10f may be used to push on an object in the user's environment. Alternatively, the outer side surfaces of either of the first projection 32, second projection 34, or either side surface of the recess 30 may be used for this purpose if the device 10 is manipulated to an appropriate angle. Surfaces on device 10 other than hook 20a may alternatively be used to pull objects in the user's environment. For example, either of the first and second projections 32, 34 or side surfaces of recess 30 may be used for this purpose by manipulating device 10 to an appropriate angle. Additionally, the user may select to engage an object in their environment with either of the top surface 10a or bottom surface 10b of the device 10.

Device 10 has been illustrated herein as including all of the various surfaces, hooks, indents, depressions etc. described above. It will be understood, however, that in other embodiments (not shown herein) one of more of the surfaces, hooks, indents, depressions etc. may be differently configured, located in a different places on the body than in the attached figures, or omitted or replaced with a differently configured surfaces or components. Furthermore, other differently configured surfaces, hooks, indents, or depressions etc. may additionally be incorporated on device.

While it has been described herein that the body of device 10 preferably is molded from a suitable polymeric material, it will be understood that in other embodiments, the body of device 10 may be die-cut from a suitable material. Other suitable materials may be metal, wood, or composite materials.

Referring to FIGS. 8A-8F, device 10 may be used to provide a method of reducing direct physical contact between a person's hand 100 and an object in the person's environment such as a door handle 104 (FIG. 8A), a door 102 (FIG. 8B), a light switch 106 or light switch plate 108 (FIG. 8C), a payment terminal 110 and buttons 112 thereon (FIG. 8D), a toilet flush handle 114 (FIG. 8E) by way of example only. The method includes providing a low touch utensil 10; holding a body of the low touch utensil 10 in one hand 100; applying a pushing force “B” (FIG. 8B) or “C” (FIG. 8D) on the object in the person's environment with a first region 10d or 32 of the body 10 as shown in FIGS. 8B or 8D. FIG. 8C shows either of a pushing force or a pulling force being applied by device 10 depending on whether light switch 106 being moved to an on or off position. The method may further include selectively applying a pulling force “A” (FIG. 8A) on the object in the person's environment with the first region 20a of the body 10 or with a second region 32, 34, 36 (FIG. 8C) of the body 10; and maintaining the person's hand 100 a distance away from the object with the body 10 while applying the pushing or pulling force. For example, in FIG. 8A body 10 keeps hand 100 a distance “D1” away from the handle 104; in FIG. 8B, body 10 keeps hand 100 a distance “D2” from the door 102; in FIG. 8C,body 10 keeps hand 100 a distance “D3” away from light switch 106; in FIG. 8D body 10 keeps hand 100 a distance “D4” away from terminal 110 and the buttons 112 thereon; and in FIG. 8E body 10 keeps hand 100 a distance “D5” away from the toilet flush handle 114.

The method further comprises providing a top surface 10a and opposed bottom surface 10b on the body of the low touch utensil 10; providing a peripheral wall 10c, 10d, 10e, 10f, 14a, 14b, 14c on the body 10, where the peripheral wall extends between the top surface 10a and the bottom surface 10b; providing the first region and the second region of the body 10 on the peripheral wall 10c, 10d, 10e, 10f, 14a, 14b, 14c; and applying the pushing force or the pulling force with the peripheral wall 10c, 10d, 10e, 10f, 14a, 14b, 14c, for example with projections 32 or 34, or with hook 20a. The method may further comprise providing a handle 16 on the body 10; holding the body by grasping the handle 16; and applying the pushing force or the pulling force with a surface of the body that is located a distance away from the handle 16, such as with projections 32, 34.

A method of reducing a likelihood of infection from bacteria or viruses on objects in a person's environment such as the door 102, handle 104, light switch 106, payment terminal 110, or toilet flush handle 114 by providing a low touch utensil 10; holding a body of the low touch utensil 10 in one hand 100; placing a surface of a first region of the body 10 in direct contact with a contaminated object in the person's environment; selectively using the body of the low touch utensil 10 to apply a pushing force “B”, for example, as shown in FIG. 8B on the contaminated object, such as a door 102 or to apply a pulling force “A”, as shown in FIG. 8A on the contaminated object, such as door handle 104; and preventing contact between the person's hand 100 and the contaminated object 102, 104, for example with the body 10 while applying the pushing or pulling force. As illustrated in FIGS. 8A and 8B, the hand 100 is kept a distance “D1” or “D2”, respectively, away from the contaminated door handle 104 or door 102.

The method may further comprise forming the body of the low touch utensil 10 from a material that includes an antimicrobial agent; and killing bacteria or viruses on an exterior surface of the body of the low touch utensil 10 with the antimicrobial agent. The method may further comprise forming the body 10 of a material that is easily cleaned and is not susceptible to damage from chemical solvents that kill viruses and/or bacteria and then cleaning the body 10 after contact with a contaminated surface or applying a chemical solvent to the body 10 in order to wash away viruses or bacteria or to kill the same.

The presently disclosed low touch utensil 10 allows people with average size hands to easily grip the device and use the same to open a door, even a heavy commercial door, or to easily grab and hold onto objects like a strap or related surface on a subway, train, or bus. Device 10 also enables people with very large hands to hold device 10 by inserting less than four fingers through the first aperture 12 of device 10, placing a thumb 100e in the first depression 26 and placing a finger, such as their ring finger or little finger, in the second depression 28 (or vice versa). Holding device 10 in this manner will still provide people having larger hands with sufficient leverage on device 10 to open a heavy door or easily hang onto a strap or another object.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is ±0.1% of the stated value (or range of values), ±1% of the stated value (or range of values), ±2% of the stated value (or range of values), ±5% of the stated value (or range of values), ±10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A device for reducing direct contact between a person's hand and an object in the person's environment, wherein the device comprises:
a body having a top surface and opposed bottom surface, and a peripheral wall extending between the top surface and the bottom surface;
a handle provided on the body;
at least one region of the body adapted to apply a pushing force on the object in the person's environment; and
at least one region of the body adapted to apply a pulling force on the object in the person's environment.

2. The device according to claim 1, wherein the at least one region of the body that applies the pushing force and the at least one region that applies the pulling force are a same region of the body.

3. The device according to claim 1, wherein the at least one region that applies the pushing force and the at least one region that applies the pulling force are different regions of the body.

4. The device according to claim 1, wherein the peripheral wall of the body includes one or more of a convex surface, a concave surface, a surface including at least one straight edge, a hook, and a projection.

5. The device according to claim 4, wherein the at least one region of the body that applies the pushing force on the object is one of the one or more of the convex surface, the concave surface, the surface including at least one straight edge, the hook, and the projection on the peripheral wall.

6. The device according to claim 4, wherein the at least one region of the body that applies the pulling force on the object is one of the one or more of the convex surface, the concave surface, the surface including at least one straight edge, the hook, and the projection on the peripheral wall.

7. The device according to claim 1, wherein the body is configured generally as a number “6” when the top surface is viewed from above.

8. The device according to claim 1, wherein the body is molded from a polymer.

9. The device according to claim 1, wherein the body is molded from a material that is one or both of cleanable and solvent resistant.

10. The device according to claim 1, wherein the body is molded from a material that includes an antimicrobial agent.

11. The device according to claim 1, wherein at least a portion of the body is overmolded.

12. The device according to claim 1, further comprising a first aperture defined in the body and extending between the top surface and the bottom surface; and wherein a first region of the body at least partially circumscribes the first aperture; and wherein the first region comprises the handle that is adapted to be held by the person.

13. The device according to claim 12, further comprising a second aperture defined in the body; wherein the first aperture and second aperture are separated from each other by a second region of the body.

14. The device according to claim 13, wherein the second aperture defined in the body originates in an opening in the peripheral wall and extends for a distance into the body; and wherein a third region of the body at least partially circumscribes the second aperture and forms a hook.

15. The device according to claim 1, further defining a hole extending between the top surface and the bottom surface, said hole being adapted to receive a fastener therethrough which secures the body to an article in the person's possession.

16. A method of reducing direct physical contact between a person's hand and an object in the person's environment comprising:
providing a low touch utensil;
holding a body of the low touch utensil in one hand;
applying a pushing force on the object in the person's environment with a first region of the body or applying a pulling force on the object in the person's environment with the first region of the body or with a second region of the body; and
maintaining the person's hand a distance away from the object with the body while applying the pushing or pulling force.

17. The method according to claim 16, further comprising;
providing a top surface and opposed bottom surface on the body of the low touch utensil;
providing a peripheral wall on the body, where the peripheral wall extends between the top surface and the bottom surface;
providing the first region and the second region of the body on the peripheral wall; and
applying the pushing force or the pulling force with the peripheral wall.

18. The method according to claim 16, further comprising:
providing a handle on the body;
holding the body by grasping the handle; and
applying the pushing force or the pulling force with a surface of the body that is located a distance away from the handle.

19. A method of reducing a likelihood of infection from bacteria or viruses on objects in a person's environment comprising:
providing a low touch utensil;
holding a body of the low touch utensil in one hand;
placing a surface of a first region of the body in direct contact with a contaminated object in the person's environment;
selectively using the body of the low touch utensil to apply a pushing force on the contaminated object or to apply a pulling force on the contaminated object; and
preventing contact between the person's hand and the contaminated object with the body while applying the pushing or pulling force.

20. The method according to claim 19, further comprising:
forming the body of the low touch utensil from a material that includes an antimicrobial agent; and
killing bacteria or viruses on an exterior surface of the body of the low touch utensil with the antimicrobial agent.

21. The device according to claim 12, wherein the first aperture is of a size sufficient to receive four fingers of a person's hand therethrough.

22. The method according to claim 18, wherein the providing of the handle on the body includes defining a first aperture in the body, wherein the first aperture extends between a first surface and a second surface of the body; and wherein the method further comprises:
inserting four fingers of a user's hand through the first aperture; and
gripping a portion of the body in the user's hand; wherein the portion of the body extends between the first aperture and a peripheral edge of the body.

23. The method according to claim 19, wherein the holding of the low touch utensil in one hand includes:
inserting four fingers of a user's hand through a first aperture defined in the body of the low touch utensil; and
gripping a portion of the body in a palm of the user's hand; wherein the portion of the body extends between the first aperture and a peripheral edge of the body.
